(19) United States
(12) Patent Application Publication
(10) Pub. No.: US 2022/0009077 A1
(43) Pub. Date: Jan. 13, 2022

(54) Leverage Extending Tool

(71) Applicant: Donald Burhans, Tucson, AZ (US)

(72) Inventor: Donald Burhans, Tucson, AZ (US)

(21) Appl. No.: 17/372,609

(22) Filed: Jul. 12, 2021

Related U.S. Application Data
(60) Provisional application No. 63/050,200, filed on Jul. 10, 2020.

(51) Int. Cl. B25G 1/10; B25G 3/04

(52) U.S. Cl. CPC B25G 1/105; B25G 3/04

(57) ABSTRACT

A leverage extending tool is provided. The device includes an elongated body having a first end and a second end. The first end includes a working end. The working end can include a box wrench, an open ended wrench, or a ratchet wrench. The second end includes a socket adapter aperture. The socket adapter aperture is linearly aligned with the elongated body. The socket adapter aperture includes a rectangle opening linearly aligned with the elongated body. The socket adapter aperture further includes smooth inner faces. The socket adapter aperture is adapted to receive a socket wrench or a breaker bar. This allows the user to apply additional torque to the wrench.

### CROSS REFERENCE TO RELATED APPLICATIONS

This application claims the benefit of U.S. Provisional Application No. 63/050,200 filed on Jul. 10, 2020. The above identified patent application is herein incorporated by reference in its entirety to provide continuity of disclosure.

### BACKGROUND OF THE INVENTION

The present invention relates to a leverage tool. More specifically, the present invention provides a leverage extending tool that has allows users to secure a nut or bolt that are positioned in a hard to reach area.

Whether working on an automobile or within a home, there can often be a bolt or another fastener that may be difficult to access. Due to the position of the fastener or tine obstacles that surround the fastener, an individual may be restricted in their ability to reach the fastener. Moreover, to compensate for the inaccessibly of the fastener the individual will strenuously reach for the fastener with their tool or generate a makeshift extension apparatus that will allow the tool to reach the fastener. When the individual is being hampered by surrounding obstacles, the duration of time it may take the individual to adjust the fastener can significant delay the individual's effort to either tighten or loosen the fastener.

Standard tools that are used to adjust fasteners include a box wrench, an open ended wrench, and a ratchet wrench. Due to the size of the standard tools, it can be difficult to for a user to reach the desired fastener. In order for the user to position the standard tool in such a way to contact the desired fastener, they may often secure an extension to the standard tool. The extension will allow for the standard tool to reach the desired fastener. However, the extension is usually connected to the tool in such a way that the tools is flimsy affixed to the extension. When the connection between the extension and the standard tool lack sufficient support, the individual might have a difficult time adjusting the desired fastener accordingly.

The fastener that an individual is attempting to loosen may be tightly secured to the surface. Adjusting a tightly secured fastener will require the user to exert a significant amount of effort. When using an extension for standard tools, users will often lose the ability create the necessary torque to adjust the fastener. Thus, for the individual to create the torque to adjust a fastener with a standard tool, they may require additional leverage. A tool, such as a breaker bar, can assist an individual to achieve maximum leverage when they want to remove a bolt that is inaccessible. The breaker bar can include additional length that generates the same amount of force to create significantly more torque to break loose tight fasteners than a standard length socket wrench.

Therefore, there is a defined need amongst the known prior art references for a leverage extending tool wherein a socket wrench or a breaker bar may be attached thereon.

### SUMMARY OF THE INVENTION

In view of the foregoing disadvantages inherent in the known types of leverage tools now present in the known art, the present invention provides a new leverage extending tool wherein a socket wrench or a breaker bar may be attach to allow users to secure a nut or bolt that are positioned in hard to reach area.

It is therefore an object of the present invention to provide a tool that includes a socket adapter aperture. The socket adapter aperture is linearly aligned with the end of the tool that engages with a fastener. In one embodiment of the tool, the socket adapter aperture is a rectangle opening that can engage with a socket wrench or a breaker bar to the tool to make a rigid connection. When the socket wrench or the breaker bar are rigidly connected to the tool, the tool will be able to engage the desired fastener. Even if the fastener is inaccessible for the user, the rigid connection between the tool and the socket wrench or the breaker bar will allow the working end of the tool to extend to the fastener.

Moreover, the rigid connection between the tool and the socket wrench or the breaker bar prohibit any loss of movement. When a makeshift tool is used to extend a tool, such as a pipe or hooking another wrench, the tool loses the necessary leverage to be effective. However, with the rigid connection the tool is be able to have enough leverage to adjust fastener, accordingly. The rigid connection eliminates loss of movement that a makeshift extender will generate and render the tool ineffective.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the leverage extending tool.

FIG. 2 shows a perspective view of an embodiment of the leverage extending tool in use.

FIG. 3 shows a perspective view of an embodiment of the leverage extending tool in use.

### DETAILED DESCRIPTION OF THE INVENTION

Reference is made herein to the attached drawings. Like reference numerals are used throughout the drawings to depict like or similar elements of the leverage extending tool. The figures are intended for representative purposes only and should not be limiting in any respect.

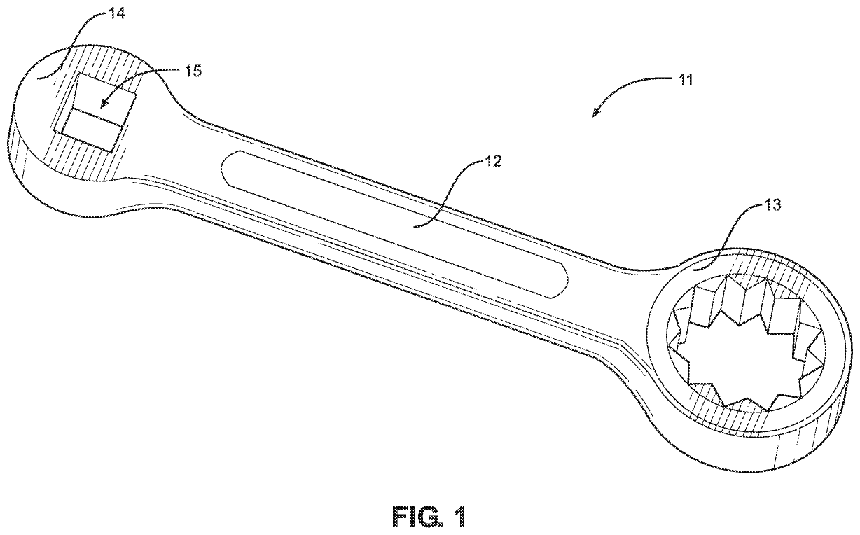

FIG. 1 shows a perspective view of an embodiment of a leverage extending tool. The leverage extending tool 11 comprising an elongated body 12. The elongated body 12 includes a pair of opposing ends consisting of a first end and a second end. The first end and the second end are on opposing ends of the elongated body 12. The first end comprises a working end 13. The second end 14 comprises a socket adapter aperture 15. The socket adapter aperture 15 is linearly aligned with the elongated body 12.

The working end 13 has a plurality of configurations. In one embodiment of the leverage extending tool, the working end 13 comprises a box wrench. In another embodiment of the leverage extending tool, a second configuration of the working end 13 comprises an open wrench. In yet another embodiment of the leverage extending tool, a third configuration of the working end 12 comprises a ratchet wrench.

The socket adapter aperture 15 extends through the second end 14. The socket adapter aperture 15 is configured in a rectangular shape. Additionally, the socket adapter aperture 15 comprises smooth inner faces. The socket adapter aperture 15 is configured to accept a socket wrench or a breaker bar therein.

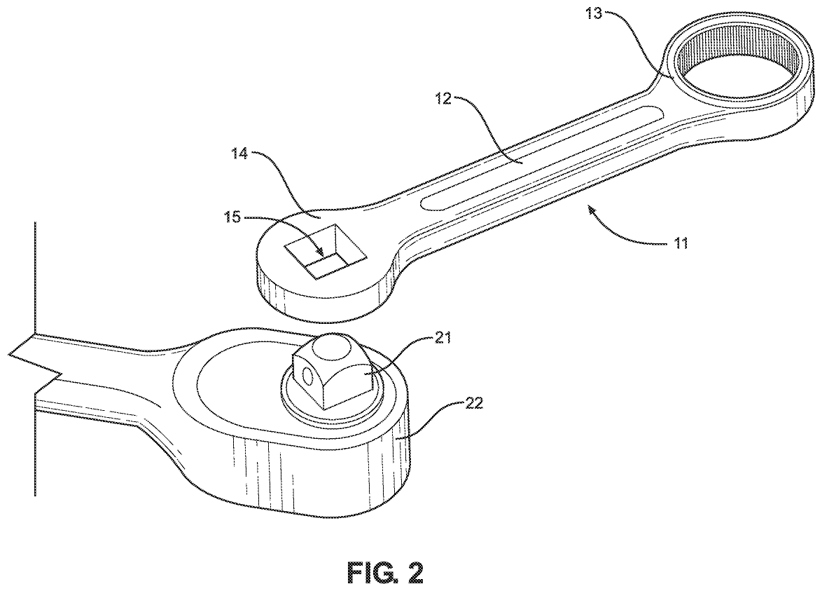

FIG. 2 shows a perspective view of an embodiment of a leverage extending tool in use. The leverage extending tool 11 is configured to engage with a socket wrench 22. The socket wrench 22 includes an elevated drive head 21. In use, the elevated drive head 21 will engage with the socket adapter aperture 15. When the socket wrench 22 is connected to the leverage extending tool 11, the working end 13 engages the desired fastener. Depending on the fastener that the user needs to tighten, the desired working end 13 will be used. When the user rotates the socket wrench 22, the leverage extending tool 11 will have corresponding movement because of the rotation of the socket wrench 22. The corresponding movement of the leverage extending tool 11 will allow the desired fastener to be tightened. In this way, the user will be able to appropriately secure the desired fastener that is in a location that is not easily accessible.

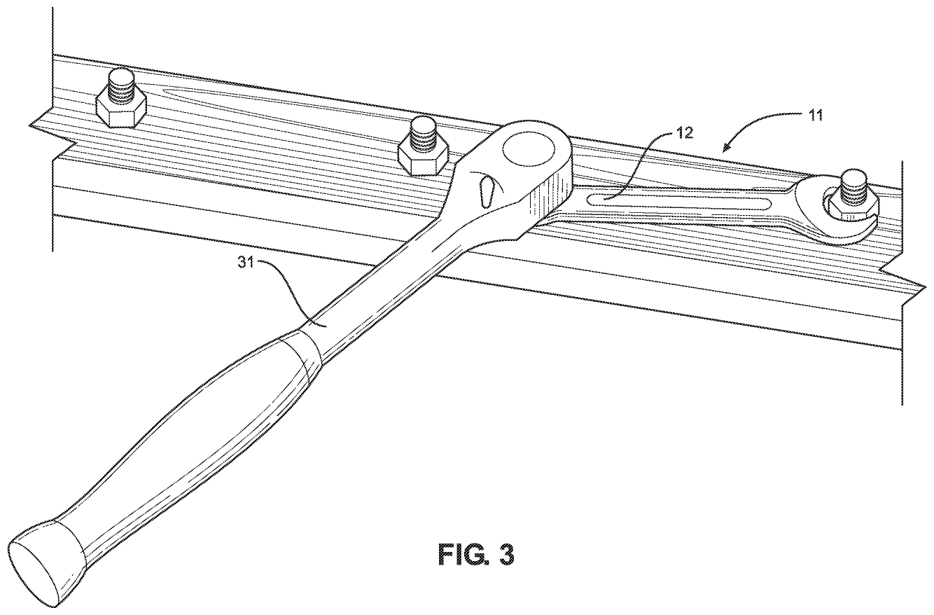

FIG. 3 shows a perspective view of an embodiment of a leverage extending tool in use. The leverage extending tool 11 can engage with a breaker bar 31. The breaker bar 31 includes a drive head. In use, the drive head will engage with the socket adapter aperture. When the breaker bar 31 is connected to the leverage extending tool 11, the working end 13 engages a fastener 32. Depending on the fastener 32 that the user needs to tighten, the desired working end 13 will be used. In the shown embodiment, the fastener 32 is a nut. To tighten the nut, an open wrench configuration of the working end 13 is utilized. When the user rotates the breaker bar 31, the leverage extending tool 11 shill have corresponding movement because of the rotation of the breaker bar 1. The corresponding movement of the leverage extending tool 11 will allow he fastener 32 to be tightened. In this way, the user will be able to appropriately secure the fastener that is in a location that is not easily accessible.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships o those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A leverage extending tool, comprising:
an elongated body;
wherein the elongated body includes a first end and a second end;
wherein the first end comprises a working end;
wherein the second end comprises a socket adapter aperture; and
whereby the socket adapter aperture is linearly aligned with the elongated body.

2. The leverage extending tool of claim 1, wherein the working end comprises a box wrench.

3. The leverage extending tool of claim 1, wherein the working end comprises an open ended wrench.

4. The leverage extending tool of claim 1, wherein the working end comprises a ratchet wrench.

5. The leverage extending tool of claim 1, wherein the socket adapter aperture is configured in a rectangle.

6. The leverage extending tool of claim 1, wherein the socket adapter includes smooth inner faces.

7. The leverage extending tool of claim 1, wherein the socket adapter aperture can receive a socket wrench or a breaker bar therein.
